(19) United States
(12) Patent Application Publication
(10) Pub. No.: US 2026/0307409 A1
(43) Pub. Date: Oct. 8, 2026

(54) CONTROL METHOD FOR PRINTING APPARATUS AND PRINTING APPARATUS

(71) Applicant: SEIKO EPSON CORPORATION, Tokyo (JP)

(72) Inventor: Ryosuke BAN, SHIOJIRI-SHI (JP)

(21) Appl. No.: 19/639,359

(22) Filed: Apr. 6, 2026

(30) Foreign Application Priority Data
Apr. 7, 2025 (JP) 2025-062955

(51) Int. Cl. B41J 15/16; B41J 15/04

(52) U.S. Cl. CPC B41J 15/165; B41J 15/04

(57) ABSTRACT

In a control method for a printing apparatus including a conveying unit that conveys an elongated medium by intermittent conveyance, the intermittent conveyance includes a plurality of conveyance operations having conveyance conditions different from one another, a control unit determines an adjustment condition of an adjustment mechanism based on a predetermined conveyance condition before the conveying unit executes a conveyance operation based on the predetermined conveyance condition and causes the adjustment mechanism to execute an adjustment operation based on the adjustment condition, and the predetermined conveyance operation and the adjustment operation are synchronized.

The present application is based on, and claims priority from JP Application Serial Number 2025-062955, filed Apr. 7, 2025, the disclosure of which is hereby incorporated by reference herein in its entirety.

### BACKGROUND

### 1. Technical Field

The present disclosure relates to a control method for a printing apparatus and a printing apparatus.

### 2. Related Art

In a printing apparatus that performs printing on an elongated medium, it is known to use a tension bar that applies tension to the medium in order to prevent wrinkles and skewing due to conveyance. In the printing apparatus, the tension bar moves by its own weight or an actuator and applies a load to the medium to generate tension.

For example, a printer apparatus described in JP-A-2012-254887 includes a feeding mechanism that feeds a print medium before print processing wound in a roll shape around a supply shaft toward a printing mechanism, and a winding mechanism that winds the print medium on which the print processing is performed by the printing mechanism around a winding shaft in a roll shape. The printer apparatus detects a position change of the moving tension bar by a photosensor, and controls the feeding mechanism and the winding mechanism so as to return the position-changed tension bar to a predetermined position set in advance.

JP-A-2012-254887 is an example of the related art.

However, in a printer that performs intermittent operation, the conveyance velocity or the conveyance amount of the medium may change, and in the control method of the related art, the movement of the tension bar cannot follow the conveyance of the medium, and the position of the tension bar may deviate from a predetermined range.

### SUMMARY

A control method for a printing apparatus according to an aspect of the present disclosure is a control method for a printing apparatus including a conveying unit that conveys an elongated medium by intermittent conveyance, a printing unit that performs printing on the medium conveyed by the conveying unit, an adjustment mechanism that has a shaft, holds the medium in a state of a roll body, and adjusts a length of the medium between the conveying unit and itself by rotating the shaft about an axis, a tension applying unit that is disposed between the adjustment mechanism and the printing unit in a conveyance path and applies tension to the medium by moving a position thereof, and a control unit that controls an operation of the conveying unit, an operation of the printing unit, and an operation of the adjustment mechanism, and the intermittent conveyance includes a plurality of conveyance operations having conveyance conditions different from one another. The control method includes determining an adjustment condition of the adjustment mechanism based on a predetermined conveyance condition before the conveying unit executes a predetermined conveyance operation based on the predetermined conveyance condition by the control unit, and causing the adjustment mechanism to execute an adjustment operation based on the adjustment condition by the control unit, wherein the predetermined conveyance operation and the adjustment operation are synchronized.

A printing apparatus according to an aspect of the present disclosure includes a conveying unit that conveys an elongated medium by intermittent conveyance, a printing unit that performs printing on the medium conveyed by the conveying unit, an adjustment mechanism that has a shaft, holds the medium in a state of a roll body, and adjusts a length of the medium between the conveying unit and itself by rotating the shaft about an axis, a tension applying unit that is disposed between the adjustment mechanism and the printing unit in a conveyance path and applies tension to the medium by moving a position thereof, and a control unit that controls an operation of the conveying unit, an operation of the printing unit, and an operation of the adjustment mechanism, wherein the intermittent conveyance includes a plurality of conveyance operations having conveyance conditions different from one another, the control unit determines an adjustment condition of the adjustment mechanism based on a predetermined conveyance condition before the conveying unit executes a predetermined conveyance operation based on the predetermined conveyance condition and causes the adjustment mechanism to execute an adjustment operation based on the adjustment condition, and the predetermined conveyance operation and the adjustment operation are synchronized.

### BRIEF DESCRIPTION OF THE DRAWINGS

FIG. 1 is a side view showing a schematic configuration of a printing apparatus.

FIG. 2 is a functional block diagram of the printing apparatus.

FIG. 3 is a side view showing a feeding unit and a first tension bar.

FIG. 4 is a side view showing a winding unit and a second tension bar.

FIG. 5 is a flowchart illustrating a control method for the printing apparatus.

FIG. 6 is a flowchart illustrating a method of estimating an outer diameter dimension of a roll body.

FIG. 7 illustrates a relationship between a conveying velocity and a feeding velocity.

FIG. 8 illustrates a relationship between a conveyance amount and a feeding amount.

FIG. 9 is a schematic diagram illustrating the method of estimating the outer diameter dimension of the roll body.

FIG. 10 is a side view showing a feeding unit and a dancer bar according to a second embodiment.

### DESCRIPTION OF EMBODIMENTS

### First Embodiment

A printing apparatus 1 according to a first embodiment will be described with reference to the drawings. The printing apparatus 1 is, for example, an inkjet printer that prints an image such as a character or a photograph by ejecting ink onto a medium M such as elongated paper or cloth.

For convenience of description, an X axis, a Y axis, and a Z axis are illustrated as three axes orthogonal to one another in the drawings. The directions along the X axis are referred to as “X-axis directions”, the directions along the Y axis are referred to as “Y-axis directions”, and the directions along the Z axis are referred to as “Z-axis directions”. An arrow side of each axis is also referred to as “plus side” and a side opposite to the arrow is also referred to as “minus side”. The Z-axis direction is a vertical direction, and the +Z direction is an upward direction, and the-Z direction is a downward direction.

### 1. Configuration of Printing Apparatus

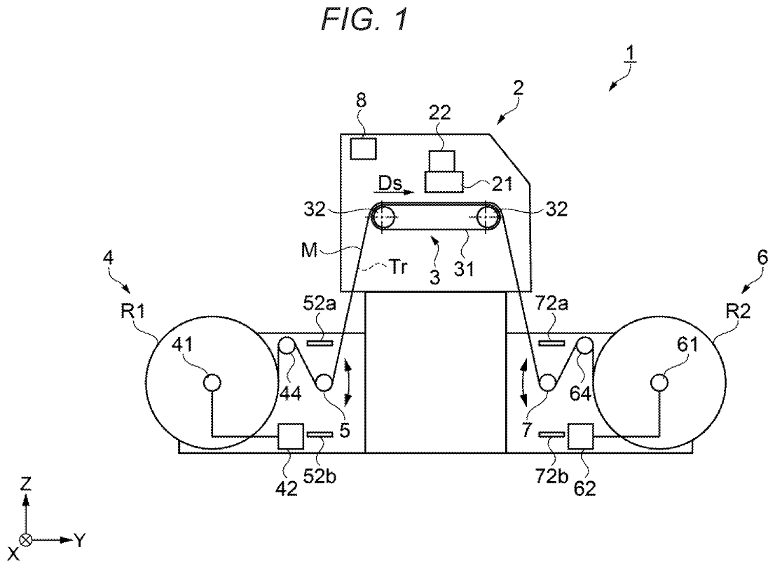

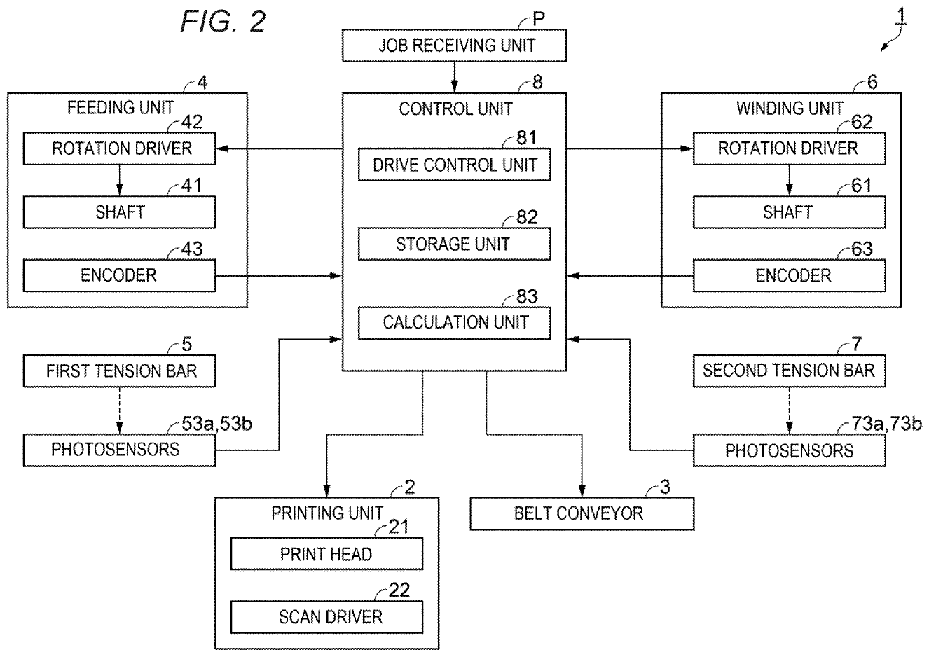

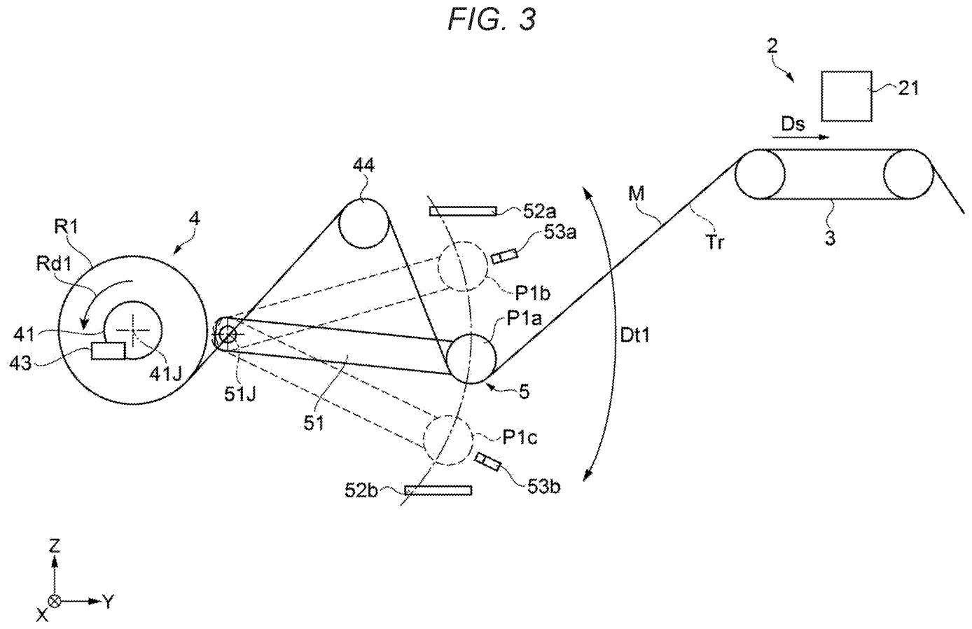

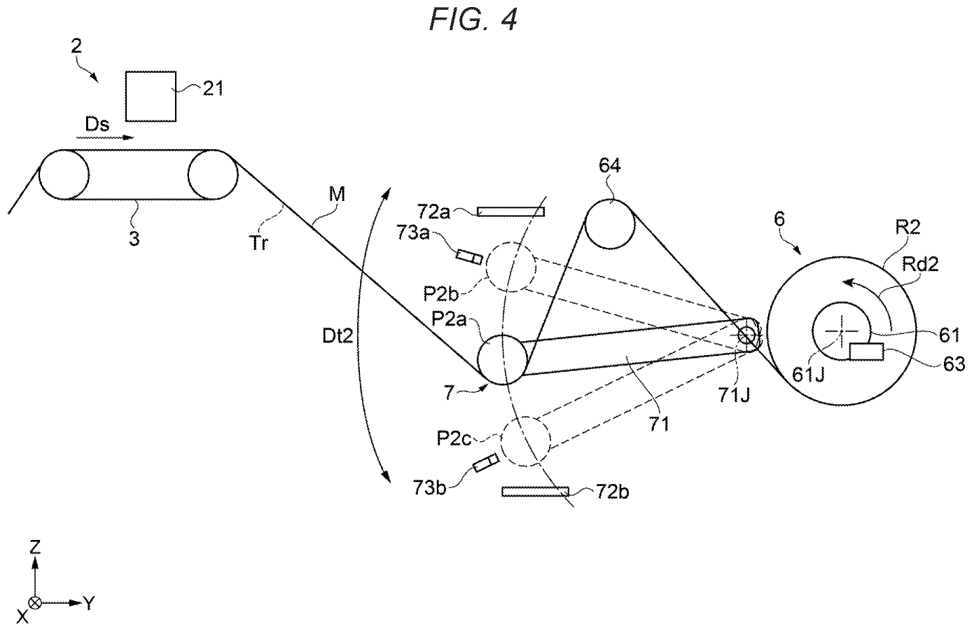

A configuration of the printing apparatus 1 will be described. FIG. 1 is a side view showing a schematic configuration of the printing apparatus 1. FIG. 2 is a functional block diagram of the printing apparatus 1. FIG. 3 is a side view showing a feeding unit 4 and a first tension bar 5. FIG. 4 is a side view showing a winding unit 6 and a second tension bar 7. As illustrated in FIGS. 1 and 2, the printing apparatus 1 includes a printing unit 2, a belt conveyor 3, the feeding unit 4, the first tension bar 5, the winding unit 6, the second tension bar 7, and a control unit 8.

The feeding unit 4 feeds the medium M, and the belt conveyor 3 conveys the fed medium M. The printing unit 2 performs printing on the medium M conveyed by the belt conveyor 3. The winding unit 6 winds the printed medium M. The first tension bar 5 applies tension to the medium M between the feeding unit 4 and the belt conveyor 3. The second tension bar 7 applies tension to the medium M between the belt conveyor 3 and the winding unit 6. The belt conveyor 3 is an example of a conveying unit. The first tension bar 5 and the second tension bar 7 are examples of a tension applying unit.

### 1.1 Control Unit

The control unit 8 has a drive control unit 81, a storage unit 82, and a calculation unit 83. The control unit 8 controls operations of the printing unit 2, the belt conveyor 3, the feeding unit 4, and the winding unit 6. The details of the control will be described below.

### 1.2 Belt Conveyor

As illustrated in FIG. 1, the belt conveyor 3 has one annular belt 31 and a plurality of pulleys 32. The plurality of pulleys 32 include at least one driving pulley. The belt 31 is rotated by the driving force from the driving pulley, and the medium M on the belt 31 is conveyed in a conveyance direction Ds. In the specification of the present application, the conveyance refers to the movement of the medium M by the belt conveyor 3.

The belt conveyor 3 intermittently conveys the medium M in response to a signal from the drive control unit 81. The intermittent conveyance is to alternately execute conveyance and stop. The single conveyance between the stops may be hereinafter referred to as a pass. In the intermittent conveyance, the conveyance operation may be different depending on the pass. In other words, the intermittent conveyance includes a plurality of conveyance operations with different conveyance conditions. The belt conveyor 3 executes conveyance for supplying the medium M before printing to the printing unit 2. Then, the belt conveyor 3 executes conveyance for removing the printed medium M from the printing unit 2.

### 1.3 Printing Unit

The printing unit 2 includes a print head 21 and a scan driver 22. The print head 21 is disposed in the +Z direction with respect to the belt conveyor 3. The print head 21 performs printing by ejecting ink onto the medium M conveyed by the belt conveyor 3. When the ink is ejected, the medium M is stationary on the belt conveyor 3.

The scan driver 22 causes the print head 21 to scan in the X-axis directions, that is, the width directions of the medium M. The scan driver 22 causes the print head 21 to scan based on a signal from the drive control unit 81. The print head 21 ejects ink while scanning. The printing apparatus 1 is a so-called serial head type.

The ink is ejected while the conveyance is stopped. While the conveyance is being performed, the ink is not ejected. That is, shortening the time required for conveyance is one factor for shortening the time required for a series of printing processes including conveyance.

### 1.4 Feeding Unit

As illustrated in FIGS. 1 to 3, the feeding unit 4 includes a shaft 41, a rotation driver 42, an encoder 43, and a guide roller 44. The feeding unit 4 is disposed at the −Y side with respect to the belt conveyor 3. The feeding unit 4 feeds the medium M toward the belt conveyor 3.

The shaft 41 has a tubular portion (not shown) extending in the X-axis directions. The length of the tubular portion in the X-axis directions is longer than the length of the medium M in the width directions. The shaft 41 is supported by bearings (not shown) provided at both ends of the tubular portion. The shaft 41 rotates about a rotation axis 41J parallel to the X axis.

The rotation driver 42 receives a signal from the drive control unit 81 and rotationally drives the shaft 41 about the rotation axis 41J. The rotation driver 42 includes, for example, a servo motor as a drive source. The rotation driver 42 can change a velocity, a rotation time, a rotation angle, and the like in the rotation of the shaft 41.

The encoder 43 is disposed at an end of the shaft 41 and detects rotation information of the shaft 41. The rotation information is, for example, a rotation position, a rotation angle, and a rotation speed of the shaft 41. The information detected by the encoder 43 is transmitted to the control unit 8. The drive control unit 81 controls the rotation of the shaft 41 based on the received rotation information. The encoder 43 is, for example, a rotary encoder.

The shaft 41 holds the medium M in the state of a roll body R1 at the outer circumference side of the tubular portion. The held medium M is wound around the outer circumference of the tubular portion. When the shaft 41 rotates in a direction Rd1 about the rotation axis 41J, the medium M is fed toward the belt conveyor 3 in a conveyance path Tr. The conveyance path Tr is a path through which the medium M passes when being conveyed. By feeding the medium M, it is possible to adjust the length of the medium M between the feeding unit 4 and the belt conveyor 3. Therefore, the feeding unit 4 is an example of an adjustment mechanism that adjusts the length of the medium M. The operation of adjusting the length of the medium M corresponds to an adjustment operation.

The guide roller 44 is disposed between the shaft 41 and the first tension bar 5 in the conveyance path Tr. The conveyance direction of the medium M is changed by the guide roller 44. In FIGS. 1 and 3, the single guide roller 44 is shown, but the number is not particularly limited. For example, the number of guide rollers 44 may be plural or zero. When the feeding unit 4 does not have the guide roller 44, the feeding may be performed by holding the roll body R1 on the shaft 41 such that the winding direction is reversed and rotating the shaft 41 in a direction opposite to the direction Rd1.

### 1.5 First Tension Bar

As illustrated in FIGS. 1 and 3, the first tension bar 5 is disposed between the shaft 41 and the belt conveyor 3 in the conveyance path Tr. Specifically, the first tension bar 5 is disposed between the guide roller 44 and the belt conveyor 3. The first tension bar 5 has a cylindrical shape extending in the X-axis directions. The length of the first tension bar 5 in the X-axis directions is longer than the length of the medium M in the width directions.

The printing apparatus 1 further has an arm 51, stoppers 52a and 52b, and photosensors 53a and 53b.

The arm 51 supports the first tension bar 5 at one end side. The arm 51 has a rotation shaft 51J parallel to the X axis at the other end side, and is rotatable around the rotation shaft 51J. As the arm 51 rotates, the first tension bar 5 swings in directions Dt1. The position of the first tension bar 5 changes by swinging.

The first tension bar 5 comes into contact with the medium M at the −Z side. The first tension bar 5 applies a force in the −Z direction to the medium M by its own weight. Tension in the conveyance direction is applied to the medium M by the applied force.

The stoppers 52a and 52b restrict the movement of the first tension bar 5. The stopper 52a is an upper stopper, and the stopper 52b is a lower stopper. The stoppers 52a and 52b physically restrict the movement of the first tension bar 5 by coming into contact with the first tension bar 5 or the arm 51. The stoppers 52a and 52b are so-called mechanical stoppers.

The first tension bar 5 is displaced according to a difference between a conveyance velocity Vs of the medium M by the belt conveyor 3 and a feeding velocity Vp of the medium M by the shaft 41. That is, when the conveyance velocity Vs is faster than the feeding velocity Vp, the medium M is pulled by the belt conveyor 3. In this case, the first tension bar 5 moves to the +Z side. When the conveyance velocity Vs is slower than the feeding velocity Vp, the medium M is loosened. In this case, the first tension bar 5 moves to the −Z side.

A movable range of the first tension bar 5 while the printing apparatus 1 is executing the series of printing processes is set in advance. The movable range corresponds to a predetermined range. The movable range includes positions P1a, P1b, and P1c. The set range is stored in the storage unit 82. The set range is a range between a predetermined position at the −Z side of the stopper 52a and a predetermined position at the +Z side of the stopper 52b.

The photosensors 53a and 53b are disposed to face the movable range of the first tension bar 5. The photosensor 53a is disposed at the +Z side with respect to the photosensor 53b.

The photosensors 53a and 53b detect the position of the first tension bar 5. The photosensors 53a and 53b are examples of a position detector. Specifically, the photosensors 53a and 53b detect that the detection target portion of the arm 51 is present at the positions where the photosensors 53a and 53b face. Further, the photosensors 53a and 53b detect that the detection target portion of the arm 51 has passed through the positions where the photosensors face. The photosensors 53a and 53b transmit the determination results to the control unit 8, and the calculation unit 83 detects the position of the first tension bar 5 based on the signals from the photosensors 53a and 53b.

The photosensor 53a detects that the first tension bar 5 is present at the position P1b or has passed through the position P1b. The photosensor 53b detects that the first tension bar 5 is present at the position P1c or has passed through the position P1c.

The drive control unit 81 receives the signals from the photosensors 53a and 53b and controls the rotation of the shaft 41 to position the first tension bar 5 within the predetermined range. For example, when it is detected that the first tension bar 5 is at the position P1b or when it is determined that the first tension bar 5 has passed through the position P1b from the −Z side to the +Z side, the drive control unit 81 controls the rotation of the shaft 41 to increase the length of the medium M from the feeding unit 4 to the belt conveyor 3.

Or, when it is detected that the first tension bar 5 is at the position P1c or when it is determined that the first tension bar 5 has passed through the position P1c from the +Z side to the −Z side, the drive control unit 81 controls the rotation of the shaft 41 to decrease the length of the medium M from the feeding unit 4 to the belt conveyor 3.

The rotation condition of the shaft 41 for adjusting the length of the medium M includes at least one of the rotation velocity, the rotation time, the rotation angle, and the rotation speed of the shaft 41. The rotation condition is an example of an adjustment condition.

The detection target of the photosensors 53a and 53b is not particularly limited to the arm 51, and for example, the detection target may be the first tension bar 5.

### 1.6 Winding Unit

As illustrated in FIGS. 1, 2, and 4, the winding unit 6 includes a shaft 61, a rotation driver 62, an encoder 63, and a guide roller 64. The winding unit 6 is disposed at the +Y side with respect to the belt conveyor 3. The winding unit 6 winds the medium M conveyed from the belt conveyor 3.

The shaft 61 has a tubular portion (not shown) extending in the X-axis directions. The length of the tubular portion in the X-axis directions is longer than the length of the medium M in the width directions. The shaft 61 is supported by bearings (not shown) provided at both ends of the tubular portion. The shaft 61 rotates about a rotation axis 61J parallel to the X axis.

The rotation driver 62 receives a signal from the drive control unit 81 and rotationally drives the shaft 61 about the rotation axis 61J. The rotation driver 62 includes, for example, a servo motor as a drive source. The rotation driver 62 can change a velocity, a rotation time, a rotation angle, and the like in the rotation of the shaft 61.

The encoder 63 is disposed at an end of the shaft 61 and detects rotation information of the shaft 61. The rotation information is, for example, a rotation position, a rotation angle, and a rotation speed of the shaft 61. The information detected by the encoder 63 is transmitted to the control unit 8. The drive control unit 81 controls the rotation of the shaft 61 based on the received rotation information. The encoder 63 is, for example, a rotary encoder.

The shaft 61 holds the medium M in the state of a roll body R2 at the outer circumference side of the tubular portion. The held medium M is wound around the outer circumference of the tubular portion. When the shaft 61 rotates in a direction Rd2 about the rotation axis 61J, the medium M conveyed from the belt conveyor 3 is wound. By winding the medium M, it is possible to adjust the length of the medium M between the belt conveyor 3 and the winding unit 6. Therefore, the winding unit 6 is an example of the adjustment mechanism that adjusts the length of the medium M.

The guide roller 64 is disposed between the second tension bar 7 and the shaft 61 in the conveyance path Tr. The conveyance direction of the medium M is changed by the guide roller 64. In FIGS. 1 and 4, the single guide roller 64 is shown, but the number is not particularly limited. For example, the number of guide rollers 64 may be plural or zero. When the winding unit 6 does not have the guide roller 64, the winding may be performed by holding the roll body R2 on the shaft 61 such that the winding direction is reversed and rotating the shaft 61 in a direction opposite to the direction Rd2.

### 1.7 Second Tension Bar

As illustrated in FIGS. 1 and 4, the second tension bar 7 is disposed between the belt conveyor 3 and the shaft 61 in the conveyance path Tr. Specifically, the second tension bar 7 is disposed between the belt conveyor 3 and the guide roller 64. The second tension bar 7 has a cylindrical shape extending in the X-axis directions. The length of the second tension bar 7 in the X-axis directions is longer than the length of the medium M in the width directions.

The printing apparatus 1 further has an arm 71, stoppers 72a and 72b, and photosensors 73a and 73b.

The arm 71 supports the second tension bar 7 at one end side. The arm 71 has a rotation axis 71J parallel to the X axis at the other end side, and is rotatable about the rotation axis 71J. As the arm 71 rotates, the second tension bar 7 swings in directions Dt2. The position of the second tension bar 7 changes by swinging.

The second tension bar 7 comes into contact with the medium M at the −Z side. The second tension bar 7 applies a force in the −Z direction to the medium M by its own weight. Tension in the conveyance direction is applied to the medium M by the applied force.

The stoppers 72a and 72b restrict the movement of the second tension bar 7. The stopper 72a is an upper stopper, and the stopper 72b is a lower stopper. The stoppers 72a and 72b physically restrict the movement of the second tension bar 7 by coming into contact with the second tension bar 7 or the arm 71. The stoppers 72a and 72b are so-called mechanical stoppers.

The second tension bar 7 is displaced according to a difference between the conveyance velocity Vs of the medium M by the belt conveyor 3 and the winding velocity of the medium M by the shaft 61. That is, when the conveyance velocity Vs is slower than the winding velocity, the medium M is pulled by the shaft 61. In this case, the second tension bar 7 moves to the +Z side. When the conveyance velocity Vs is faster than the winding velocity, the medium M is loosened. In this case, the second tension bar 7 moves to the −Z side.

A movable range of the second tension bar 7 while the printing apparatus 1 is executing the series of printing processes is set in advance. The movable range corresponds to a predetermined range. The movable range includes positions P2a, P2b, and P2c. The set range is stored in the storage unit 82. The set range is a range between a predetermined position at the −Z side of the stopper 72a and a predetermined position at the +Z side of the stopper 72b.

The photosensors 73a and 73b are disposed to face the movable range of the second tension bar 7. The photosensor 73a is disposed at the +Z side with respect to the photosensor 73b.

The photosensors 73a and 73b detect the position of the second tension bar 7. The photosensors 73a and 73b are examples of a position detector. Specifically, the photosensors 73a and 73b detect that the detection target portion of the arm 71 is present at the positions where the photosensors 73a and 73b face. Further, the photosensors 73a and 73b detect that the detection target portion of the arm 71 has passed through the positions where the photosensors face. The photosensors 73a and 73b transmit the determination results to the control unit 8, and the calculation unit 83 detects the position of the second tension bar 7 based on the signals from the photosensors 73a and 73b.

The photosensor 73a detects that the second tension bar 7 is present at the position P2b or has passed through the position P2b. The photosensor 73b detects that the second tension bar 7 is present at the position P2c or has passed through the position P2c.

The drive control unit 81 receives the signals from the photosensors 73a and 73b and controls the rotation of the shaft 61 to position the second tension bar 7 within a predetermined range. For example, when it is detected that the second tension bar 7 is at the position P2b, or when it is determined that the second tension bar 7 has passed through the position P2b from the −Z side to the +Z side, the drive control unit 81 controls the rotation of the shaft 61 to increase the length of the medium M from the winding unit 6 to the belt conveyor 3.

Or, when it is detected that the second tension bar 7 is at the position P2c or when it is determined that the second tension bar 7 has passed through the position P2c from the +Z side to the −Z side, the drive control unit 81 controls the rotation of the shaft 61 to decrease the length of the medium M from the winding unit 6 to the belt conveyor 3.

The rotation condition of the shaft 61 for adjusting the length of the medium M includes at least one of the rotation velocity, the rotation time, the rotation angle, and the rotation speed of the shaft 61. The rotation condition is an example of the adjustment condition.

The detection target of the photosensors 73a and 73b is not particularly limited to the arm 71, and for example, the detection target may be the second tension bar 7.

### 2. Control Method for Printing Apparatus

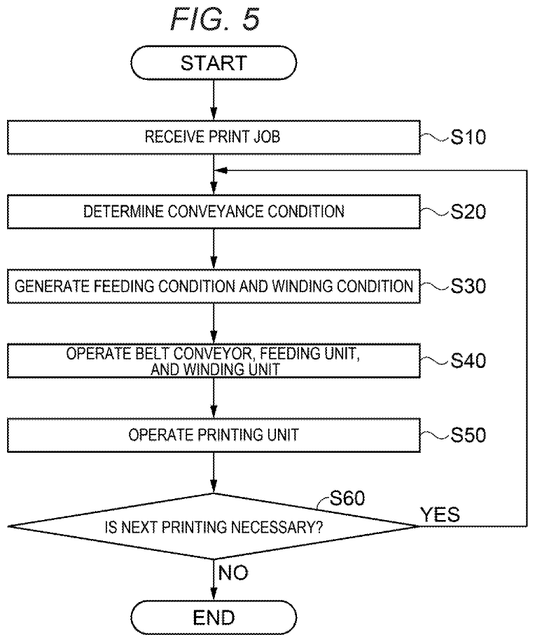

A control method for the printing apparatus 1 will be described. FIG. 5 is a flowchart illustrating the control method for the printing apparatus 1.

First, in step S10, the control unit 8 receives a print job from a job receiving unit P (see FIG. 2). The print job corresponds to a command for the printing apparatus 1 to execute the series of printing processes. For example, the print job may be input by an operator from an input receiving unit (not illustrated) provided in the main body of the printing apparatus 1. The input receiving unit of the printing apparatus 1 is, for example, a touch panel. The print job may be received from a terminal device communicably connected in a wired or wireless manner.

In step S20, the control unit 8 determines a conveyance condition for the belt conveyor 3 based on the received print job. The conveyance condition is a condition for one pass in the intermittent conveyance. The conveyance condition includes at least one of a conveyance amount, a conveyance time, and a conveyance velocity profile of the medium M. The conveyance velocity profile is a velocity change with respect to the time elapsed from the conveyance start. The determined conveyance condition corresponds to a predetermined conveyance condition.

In step S30, the control unit 8 generates a feeding condition for the feeding unit 4 and a winding condition for the winding unit 6. The feeding condition and the winding condition are determined based on the conveyance condition determined in step S20. The feeding condition and the winding condition are examples of a condition of an adjustment operation for adjusting the length of the medium M, that is, an adjustment condition. The feeding condition includes at least one of a rotation velocity, a rotation time, and a rotation angle in the shaft 41 of the feeding unit 4. The winding condition includes at least one of a rotation velocity, a rotation time, and a rotation angle in the shaft 61 of the winding unit 6.

The storage unit 82 stores predetermined values of the conveyance condition and predetermined values of the feeding condition and the winding condition. The predetermined values of the conveyance conditions are, for example, a conveyance velocity, the conveyance time, and the conveyance velocity profile. The predetermined values of the feeding condition and the winding condition are, for example, the rotation velocities, the rotation times, the rotation angles, and the rotation speeds in the shafts 41 and 61. In step S30, the feeding condition and the winding condition are determined by changing the feeding condition and the winding condition from the predetermined values based on the conveyance condition determined in step S20. For example, in the conveyance condition, when the conveyance velocity is faster than the predetermined value, the rotation velocity of the shaft 41 in the feeding condition and the rotation velocity of the shaft 61 in the winding condition are also faster than the predetermined values of the rotation velocities. For example, in the conveyance condition, when the conveyance amount is larger than the predetermined value, the rotation time of the shaft 41 in the feeding condition and the rotation time of the shaft 61 in the winding condition are also longer than the predetermined values of the rotation times.

When the feeding condition is generated in step S30, the size of the outer diameter of the roll body R1 may be considered in addition to the conveyance condition. That is, the feeding condition may be determined based on the conveyance condition and the size of the outer diameter of the roll body R1. Even when the size of the outer diameter of the roll body R1 changes during the execution of the series of printing processes, it is possible to accurately control the amount and velocity of feeding. A method of detecting the outer diameter dimension of the roll body R1 will be described later.

When the winding condition is generated in step S30, the size of the outer diameter of the roll body R2 may be considered in addition to the conveyance condition. That is, the winding condition may be determined based on the conveyance condition and the size of the outer diameter of the roll body R2. Even when the size of the outer diameter of the roll body R2 changes during the execution of the series of printing processes, it is possible to accurately control the amount and velocity of winding.

In step S40, the control unit 8 executes the conveyance operation by the belt conveyor 3, the feeding operation by the feeding unit 4, and the winding operation by the winding unit 6. The conveyance operation is executed based on the conveyance condition determined in step S20. The feeding operation and the winding operation are executed based on the feeding condition and the winding condition determined in step S30. The conveyance start, the feeding start, and the winding start are simultaneously executed. The simultaneous execution of the conveyance start and the feeding start is an example of synchronization of the predetermined conveyance operation with the adjustment operation. The simultaneous execution of the conveyance start and the winding start is an example of synchronization of the predetermined conveyance operation with the adjustment operation.

After executing the conveyance operation for one pass, the belt conveyor 3 stops the conveyance operation.

In step S50, the control unit 8 executes printing on the medium M by the printing unit 2. While printing is being executed, the conveyance operation of the belt conveyor 3 is stopped.

In step S60, the control unit 8 determines whether the next printing is necessary. When it is determined that the next printing is necessary, the process returns to step S20, and the control unit 8 determines the conveyance condition for the next one pass. Thereafter, each process is executed as described above. When it is determined that the next printing is not necessary, the series of printing processes is ended.

Although it has been described that the conveyance start, the feeding start, and the winding start are simultaneously executed in step S40, the start times of the respective operations may not completely coincide with one another. For example, the feeding operation or the winding operation may be started before the control unit 8 determines that the position adjustment of the first tension bar 5 or the second tension bar 7 is necessary. In other words, the feeding operation or the winding operation for adjusting the length of the medium M may be started before the position of the first tension bar 5 or the second tension bar 7 is detected by the photosensors 53a, 53b, 73a, and 73b. Such control is an example of synchronization of the predetermined conveyance operation with the adjustment operation.

According to the above-described control method for the printing apparatus 1, since the conveyance start, the feeding start, and the winding start are synchronized, it is possible to reduce delays of the first tension bar 5 and the second tension bar 7 with respect to the conveyance of the medium M by the belt conveyor 3. Therefore, even when the conveyance velocity and the conveyance amount of the medium M change for each conveyance pass, the positions of the first tension bar 5 and the second tension bar 7 can be kept within the predetermined ranges.

In the present embodiment, it is preferable that the time difference between the conveyance start and the feeding start is smaller. It is more preferable that the conveyance start and the feeding start are simultaneously executed. Accordingly, the position of the first tension bar 5 can be more reliably kept within the predetermined range.

In the present embodiment, it is preferable that the time difference between the conveyance start and the winding start is smaller. It is more preferable that the conveyance start and the winding start are simultaneously executed. Accordingly, the position of the second tension bar 7 can be more reliably kept within the predetermined range.

As described above, the rotation condition of the shaft 41 for adjusting the length of the medium M includes at least one of the rotation velocity, the rotation time, the rotation angle, and the rotation speed of the shaft 41. According to the configuration, since the length of the medium M can be adjusted by the rotation of the shaft 41, the predetermined conveyance operation and the adjustment operation can be easily synchronized.

As described above, the rotation condition of the shaft 61 for adjusting the length of the medium M includes at least one of the rotation velocity, the rotation time, the rotation angle, and the rotation speed of the shaft 61. According to the configuration, since the length of the medium M can be adjusted by the rotation of the shaft 61, the predetermined conveyance operation and the adjustment operation can be easily synchronized.

By using the above-described printing apparatus 1, since the conveyance start, the feeding start, and the winding start are synchronized, it is possible to reduce delays of the first tension bar 5 and the second tension bar 7 with respect to the conveyance of the medium M by the belt conveyor 3. Therefore, even when the conveyance velocity and the conveyance amount of the medium M change for each conveyance pass, the positions of the first tension bar 5 and the second tension bar 7 can be kept within the predetermined ranges.

### 3. Method of Detecting Outer Diameter Dimension of Roll Body

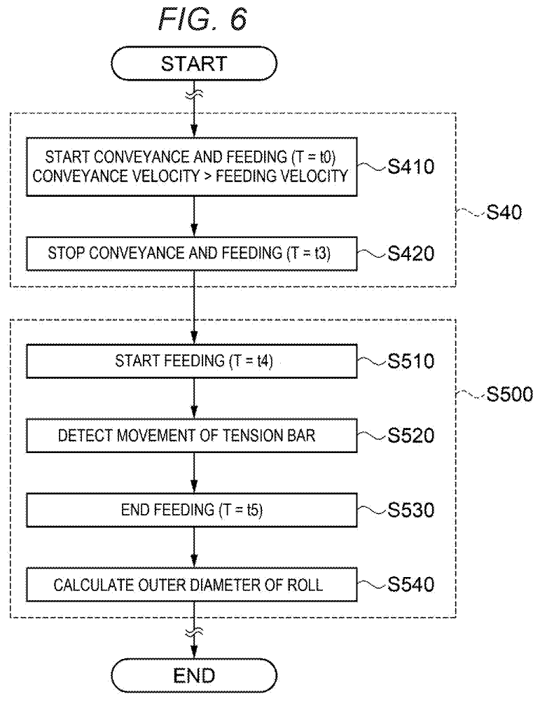

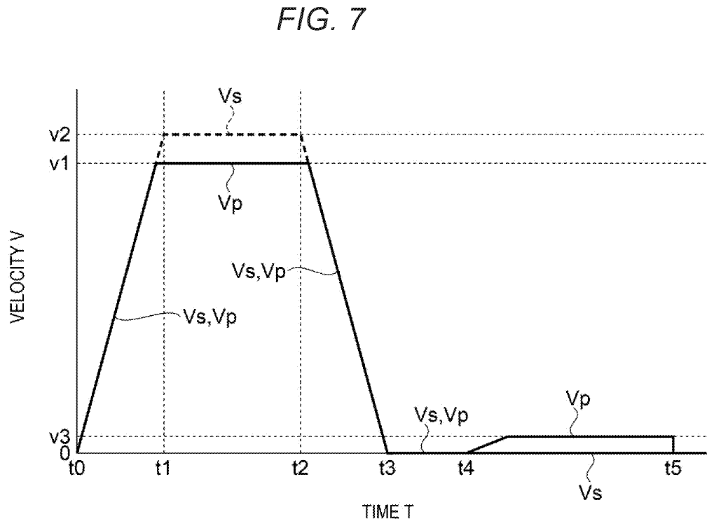

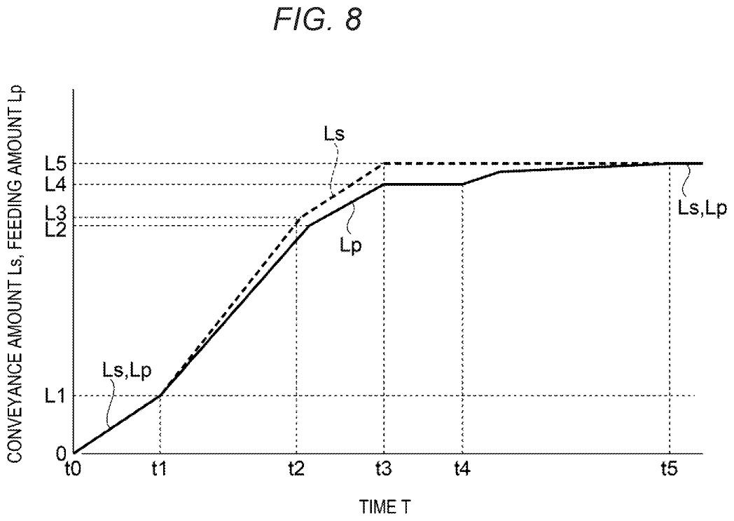

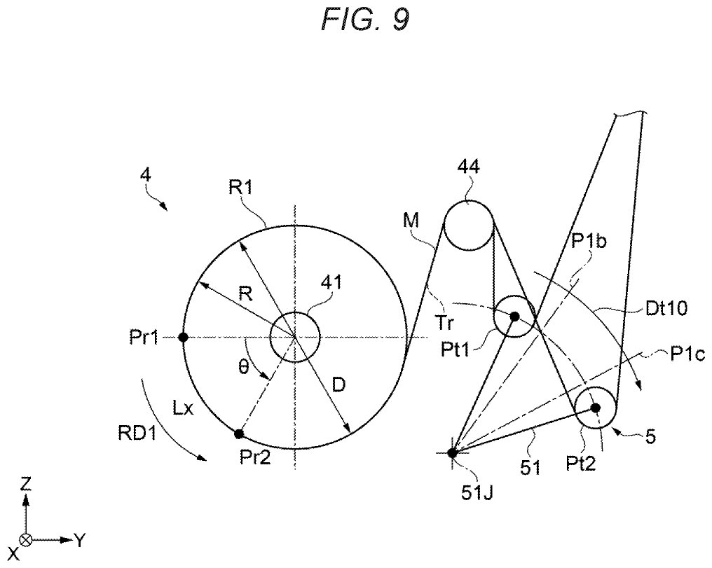

An example of the method of detecting the outer diameter dimension of the roll body R1 will be described with reference to FIGS. 6 to 9. FIG. 6 is a flowchart illustrating a method of estimating the outer diameter dimension of the roll body R1. FIG. 7 illustrates a relationship between the conveyance velocity and the feeding velocity. FIG. 8 illustrates a relationship between the conveyance amount and the feeding amount. FIG. 9 is a schematic diagram illustrating the method of estimating the outer diameter dimension of the roll body R1. In FIG. 9, the photosensors 53a and 53b are not shown. The phrase “detecting the outer diameter dimension” in the specification of the present application includes not only directly measuring the outer diameter dimension by a measuring instrument or the like, but also measuring a physical quantity other than the outer diameter dimension and estimating the outer diameter dimension by a calculation based on the measured physical quantity.

The detection of the outer diameter dimension is executed by a command from the control unit 8. The detection operation is started as the feeding operation in step S40 in FIG. 5.

First, as illustrated in FIG. 6, the conveyance and the feeding of the medium M are started in step S410. As illustrated in FIG. 7, at time T=t0, the conveyance and the feeding of the medium M are simultaneously started and accelerated toward the set maximum velocities. A maximum velocity V2 of the conveyance velocity Vs and a maximum velocity V1 of the feeding velocity Vp are set to satisfy a relationship of V1<V2. In the present specification, the maximum velocity V2 of the conveyance velocity Vs may be simply referred to as “conveyance velocity” or “conveyance velocity Vs”. The maximum velocity V1 of the feeding velocity Vp may be simply referred to as “feeding velocity” or “feeding velocity Vp”. That is, the conveyance velocity Vs is faster than the feeding velocity Vp. The accelerations of the conveyance velocity Vs and the feeding velocity Vp are set to be the same. The conveyance velocity Vs reaches the velocity V2 at time T=t1. The feeding velocity Vp reaches the velocity V1 slightly before the time T=t1.

Next, as illustrated in FIG. 6, as step S420, the conveyance and the feeding are stopped. A deceleration is started at time T=t2, and the conveyance velocity Vs is decelerated to Vs=0 at time T=t3. A deceleration is started after the feeding velocity Vp reaches the velocity V1 and a predetermined time elapses, and the feeding velocity is decelerated to Vp=0 at time T=t3. The decelerations of the conveyance velocity Vs and the feeding velocity Vp are set to be the same.

With the above-described velocity profile, as illustrated in FIG. 8, at time T=t3, the feeding amount Lp becomes L4, and the conveyance amount Ls becomes L5 larger than L4. That is, from time T=t0 to T=t3, the feeding amount Lp becomes smaller than the conveyance amount Ls. Therefore, the length of the medium M between the feeding unit 4 and the belt conveyor 3 is shorter at time T=t3 than at time T=t0.

Since the length of the medium M becomes shorter, the first tension bar 5 is positioned at the +Z side at time T=t3 compared to that at time T=t0. That is, from time T=t0 to T=t3, the first tension bar 5 moves to the +Z side. In FIG. 9, the position of the first tension bar 5 at time T=t3 is Pt1. As described above, step S40 in FIG. 5 includes step S410 and step S420.

Then, as illustrated in FIG. 6, as step S500, the outer diameter dimension of the roll body R1 is estimated. Step S500 includes steps S510 to S540 described later. Step S500 is an estimation step. Step S500 is executed in parallel with step S50 in FIG. 5. In other words, step S500 is executed when the belt conveyor 3 is stopped.

As step S510, feeding is started again. As illustrated in FIG. 7, the feeding is started at time T=t4. It is possible to stabilize the behavior of the conveyed medium M by providing the time during which the conveyance and feeding operations are stopped from time T=t3 to T=t4. The time T at which the feeding is started is not particularly limited to t4, and the time T may be t3.

Here, the feeding velocity Vp is V3, which is extremely lower than the maximum velocity V1. As illustrated in FIG. 8, the feeding amount Lp gradually increases from L4. Concurrently, the conveyance is stopped, and thus the length of the medium M between the feeding unit 4 and the belt conveyor 3 gradually increases. As the length of the medium M increases, the first tension bar 5 gradually moves to the −Z side. As illustrated in FIG. 9, the first tension bar 5 moves from the position Pt1 in a direction Dt10.

Then, as illustrated in FIG. 6, as step S520, the movement of the first tension bar 5 is detected. Specifically, in step S510, as illustrated in FIG. 9, the first tension bar 5 starts to move from the position Pt1 in the direction Dt10. When the first tension bar 5 passes through the position P1b, a signal is transmitted from the photosensor 53a to the control unit 8. Then, the control unit 8 receives the rotation position as information of the shaft 41 from the encoder 43 (see FIG. 3) disposed on the shaft 41. In the method of detecting the outer diameter dimension described here, the rotation information detected by the encoder 43 includes the rotation position. The rotation position information received by the control unit 8 here is a first signal. For convenience of description, it is assumed that a certain reference point on the outer circumference of the roll body R1 at the time is at the position Pr1.

The medium M is further fed out, and the first tension bar 5 further moves in the direction Dt10. When the first tension bar 5 passes through the position P1c, a signal is transmitted from the photosensor 53b to the control unit 8. Then, the control unit 8 receives the rotation position as information of the shaft 41 from the encoder 43 disposed on the shaft 41. The rotation position information received by the control unit 8 here is a second signal. At the time, the reference point on the outer circumference of the roll body R1 has moved from the position Pr1 to the position Pr2.

As step S530 illustrated in FIG. 6, as illustrated in FIG. 9, when the first tension bar 5 passes through the position P1c, the feeding of the medium M is stopped. The first tension bar 5 has moved to the position Pt2. The position Pt2 is located forward of the position P1c in the direction Dt10. The time T when the feeding of the medium M is stopped is T=t5 as illustrated in FIG. 7.

Then, as illustrated in FIG. 6, as step S540, the outer diameter of the roll body R1 is calculated. The calculation of the outer diameter is performed by the calculation unit 83. When a length of the medium M fed from when the first tension bar 5 passes through the position P1b to when the first tension bar passes through the position P1c is Lp1, the length Lp1 is constant. The length Lp1 corresponds to a movement amount of the medium M. The value of the length Lp1 is stored in advance in the storage unit 82 (see FIG. 2). As illustrated in FIG. 9, the length Lp1 is equal to a distance Lx by which the reference point on the outer circumference of the roll body R1 moves from the position Pr1 to the position Pr2.

The calculation unit 83 calculates a rotation angle θ [deg] of the shaft 41 illustrated in FIG. 9 based on the first signal and the second signal. The rotation angle θ is a central angle of an arc having ends at the positions Pr1 and Pr2. A radius R of the roll body R1 is obtained by the following expression (1)

$$R = ( 360 / θ ) \times ( Lp 1 / 2 π ) . \qquad ( 1 )$$

π is a circular constant. An outer diameter D of the roll body R1 is obtained by the following expression (2)

$$D = 2 \cdot R . \qquad ( 2 )$$

As described above, the printing apparatus 1 includes the photosensors 53a and 53b that detect the position of the first tension bar 5. The control unit 8 estimates the size of the outer diameter D or the radius R of the roll body R1 based on the rotation angle θ at which the shaft 41 rotates and the length Lp1 of the medium M when the first tension bar 5 moves from the position P1b to the position P1c between predetermined two points. According to the configuration, it is not necessary to directly measure the outer diameter D or the radius R of the roll body R1, and thus it is possible to avoid an increase in the number of sensors. Therefore, the apparatus configuration can be prevented from becoming complicated.

The printing in step S50 illustrated in FIG. 5 is started from time T=t3 to T=t4 shown in FIGS. 7 and 8. As described above, steps S510 to S540 are performed in parallel with execution of printing. That is, the calculation unit 83 estimates the size of the outer diameter of the roll body R1 when the print head 21 executes the printing operation. According to the configuration, the printing unit 2 can execute printing without waiting for completion of the estimation of the outer diameter of the roll body R1. The size of the outer diameter estimated here is used to generate the feeding condition in the next pass.

Although the positions of the two points through which the first tension bar 5 passes have been described as the positions P1b and P1c, the positions are not particularly limited thereto, and may be positions different from the positions P1b and P1c. In this case, a photosensor different from the photosensors 53a and 53b may be used to detect the position of the first tension bar 5.

### Modifications

Although the first embodiment has been

described above with reference to the drawings, the embodiment is not particularly limited. For example, the printing unit 2, the belt conveyor 3, the feeding unit 4, the first tension bar 5, the winding unit 6, the second tension bar 7, and the control unit 8 provided in the printing apparatus 1 are not necessarily incorporated in the same housing. In addition, these do not necessarily have to be integrally coupled by angle brackets or the like. For example, the printing unit 2 and belt conveyor 3, the feeding unit 4, and the winding unit 6 may be separated, and in this case, the present embodiment may be realized as a system.

In the description of the first embodiment, the example of the conveying unit is the belt conveyor 3, but not particularly limited thereto, and may be, for example, a roller pair. In this case, a platen may be disposed at a position facing the print head 21, and the ink may be ejected onto the medium M on the platen.

The printing unit 2 is not particularly limited to the configuration described above. For example, the printing unit 2 may not include the scan driver 22, and the print head 21 may not perform scanning in the X-axis directions.

The feeding unit 4 is not particularly limited to the configuration described above. The feeding unit 4 does not necessarily include the shaft 41, the rotation driver 42, the encoder 43, and the guide roller 44. The feeding unit 4 may have a function of feeding the medium M toward the belt conveyor 3 under the control of the control unit 8.

The winding unit 6 is not particularly limited to the configuration described above. The winding unit 6 does not necessarily include the shaft 61, the rotation driver 62, the encoder 63, and the guide roller 64. The winding unit 6 may have a function of winding the printed medium M under the control of the control unit 8.

In addition, the rotation drivers 42 and 62 have been described as being capable of controlling the velocities, the rotation times, and the rotation angles in the rotations of the shafts 41 and 61, but are not particularly limited thereto. For example, at least one of the velocities, the rotation times, and the rotation angles in the rotations of the shafts 41 and 61 may be controllable.

The detector for detecting the position of the first tension bar 5 and the position of the second tension bar 7 is not particularly limited to the photosensors 53a, 53b, 73a, and 73b. For example, the detector may be rotary encoders that detect the rotation states of the rotation shafts 51J and 71J of the arms 51 and 71.

Although it has been described that the first tension bar 5 and the second tension bar 7 apply tension to the medium M by their own weights, the present disclosure is not particularly limited thereto. For example, tension may be applied to the medium M by moving the first tension bar 5 and the second tension bar 7 by actuators. Alternatively, their own weights and the actuators may be used in combination.

Although it has been described that the conveyance start, the feeding start, and the winding start are simultaneously executed, the present disclosure is not particularly limited thereto. For example, the conveyance start and the feeding start may be simultaneously executed, and the winding start may not be simultaneously executed. Alternatively, the conveyance start and the winding start may be simultaneously executed, and the feeding start may not be simultaneously executed.

As illustrated in FIG. 5, in step S20 of the control method, the conveyance condition to be determined has been described as a condition for one pass, but is not particularly limited thereto. For example, the conveyance condition to be determined may be a condition for a plurality of passes. In this case, when it is determined in step S60 that the next printing is necessary, the process may return to step S30 without returning to step S20.

Although the step S500 shown in FIG. 6, that is, the estimation step is described as being executed when the belt conveyor 3 is stopped, the present disclosure is not particularly limited thereto. For example, steps S510 to S530 may be executed when the belt conveyor 3 is conveying. In this case, the length of the medium M to be fed is longer by the length of the medium M to be conveyed than that when the belt conveyor 3 is stopped. Therefore, when a length of the medium M conveyed by the belt conveyor 3 is Ls1, the radius R of the roll body R1 may be obtained by the following expression (3)

$$R = ( 360 / θ ) \times ( Lp 1 + LS 1 ) / 2 π . \qquad ( 3 )$$

The length Ls1 of the medium M may be estimated from, for example, the rotation amount of the pulley 32, or may be measured by a non-contact sensor or the like.

Although the method of detecting the outer diameter D or the radius R of the roll body R1 has been described, the present disclosure is not particularly limited thereto, and the outer diameter D or the radius R of the roll body R2 in the winding unit 6 may be detected. In this case, as in steps S410 to S540 illustrated in FIG. 6, the size of the outer diameter D or the radius R of the roll body R2 in the winding unit 6 may be estimated based on the rotation angle θ at which the shaft 61 in the winding unit 6 rotates and the winding length of the medium M when the second tension bar 7 moves between the position P2b and the position P2c illustrated in FIG. 4.

### Second Embodiment

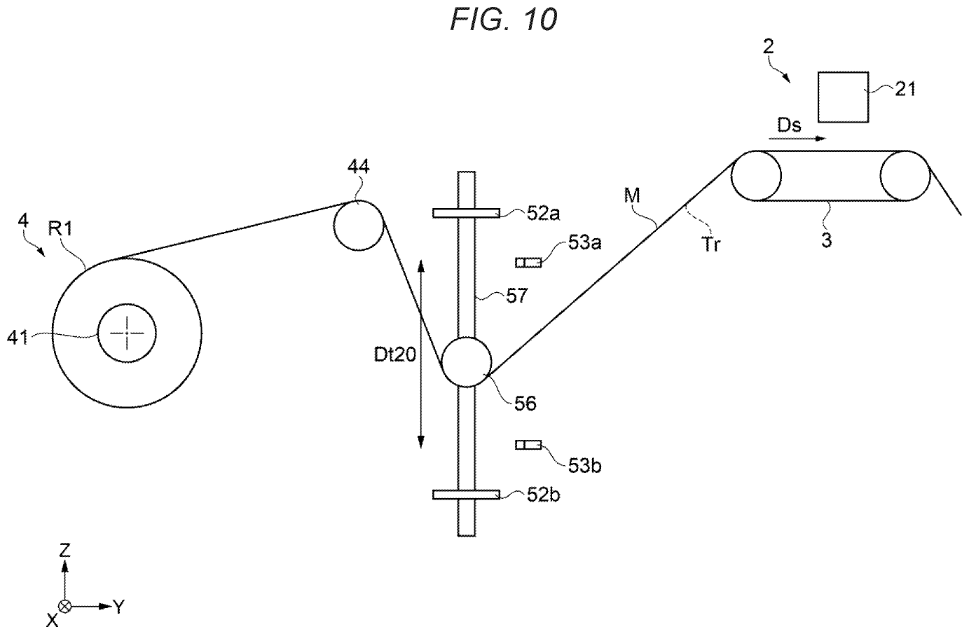

A printing apparatus 1 according to a second embodiment will be described with reference to FIG. 10. FIG. 10 is a side view showing the feeding unit 4 and a first dancer bar 56 according to the second embodiment.

As illustrated in FIG. 10, the printing apparatus 1 of the second embodiment includes the printing unit 2, the belt conveyor 3, the feeding unit 4, the first dancer bar 56, the winding unit 6 (see FIG. 2), a second dancer bar (not illustrated), and the control unit 8 (see FIG. 2). The first dancer bar 56 and the second dancer bar are examples of the tension applying unit. The printing apparatus 1 of the second embodiment is the same as the printing apparatus 1 of the first embodiment except that the first tension bar 5 is replaced with the first dancer bar 56 and the second tension bar 7 is replaced with the second dancer bar.

Since the first dancer bar 56 and the second dancer bar have the same configuration and operation, the first dancer bar 56 will be described as a representative example. The first dancer bar 56 is held by a linear motion rail 57 of the printing apparatus 1. The linear motion rail 57 is disposed to extend in the Z-axis directions. The first dancer bar 56 is held by the linear motion rail 57 and can swing in directions Dt20, that is, the Z-axis directions.

The first dancer bar 56 is disposed between the shaft 41 of the feeding unit 4 and the belt conveyor 3 in the conveyance path Tr. Specifically, the first dancer bar 56 is disposed between the guide roller 44 and the belt conveyor 3. The first dancer bar 56 has a cylindrical shape extending in the X-axis directions. The length of the first dancer bar 56 in the X-axis directions is longer than the length of the medium M in the width directions. The first dancer bar 56 comes into contact with the medium M at the −Z side. The first dancer bar 56 applies a force in the −Z direction to the medium M by its own weight. Tension in the conveyance direction is applied to the medium M by the applied force. According to the configuration, the same effects as those of the first embodiment can be obtained.

The printing apparatus 1 is not particularly limited to the configuration having the first dancer bar 56 and the second dancer bar. For example, the printing apparatus 1 may include the first dancer bar 56 and the second tension bar 7, or may include the second dancer bar and the first tension bar 5.

What is claimed is:

1. A control method for a printing apparatus including
a conveying unit that conveys an elongated medium by intermittent conveyance,
a printing unit that performs printing on the medium conveyed by the conveying unit,
an adjustment mechanism that has a shaft, holds the medium in a state of a roll body, and adjusts a length of the medium between the conveying unit and itself by rotating the shaft about an axis,
a tension applying unit that is disposed between the adjustment mechanism and the printing unit in a conveyance path and applies tension to the medium by moving a position thereof, and
a control unit that controls an operation of the conveying unit, an operation of the printing unit, and an operation of the adjustment mechanism,
the intermittent conveyance including a plurality of conveyance operations having conveyance conditions different from one another,
the control method comprising:
determining an adjustment condition of the adjustment mechanism based on a predetermined conveyance condition before the conveying unit executes a predetermined conveyance operation based on the predetermined conveyance condition by the control unit; and
causing the adjustment mechanism to execute an adjustment operation based on the adjustment condition by the control unit, wherein
the predetermined conveyance operation and the adjustment operation are synchronized.

2. The control method according to claim 1, wherein
the adjustment mechanism is a feeding unit that adjusts the length of the medium by feeding the medium from the roll body.

3. The control method according to claim 1, wherein
the adjustment mechanism is a winding unit that adjusts the length of the medium by winding the medium printed by the printing unit.

4. The control method according to claim 2, wherein
the adjustment condition includes at least one of a rotation velocity, a rotation time, a rotation angle, and a rotation speed in the shaft.

5. The control method according to claim 2, wherein
the predetermined conveyance operation and the adjustment operation start simultaneously.

6. The control method according to claim 2, wherein
the adjustment condition is determined based on the predetermined conveyance condition and a size of an outer diameter of the roll body.

7. The control method according to claim 6, wherein
the printing apparatus has a position detector that detects a position of the tension applying unit, and
the control unit estimates the size of the outer diameter of the roll body based on a rotation angle at which the shaft rotates and a movement amount of the medium when the tension applying unit moves between two predetermined points.

8. The control method according to claim 7, wherein
the control unit estimates the size of the outer diameter of the roll body when the printing unit is executing a printing operation.

9. A printing apparatus comprising:
a conveying unit that conveys an elongated medium by intermittent conveyance;
a printing unit that performs printing on the medium conveyed by the conveying unit;
an adjustment mechanism that has a shaft, holds the medium in a state of a roll body, and adjusts a length of the medium between the conveying unit and itself by rotating the shaft about an axis;
a tension applying unit that is disposed between the adjustment mechanism and the printing unit in a conveyance path and applies tension to the medium by moving a position thereof; and
a control unit that controls an operation of the conveying unit, an operation of the printing unit, and an operation of the adjustment mechanism, wherein
the intermittent conveyance includes a plurality of conveyance operations having conveyance conditions different from one another, and
the control unit determines an adjustment condition of the adjustment mechanism based on a predetermined conveyance condition before the conveying unit executes a predetermined conveyance operation based on the predetermined conveyance condition and causes the adjustment mechanism to execute an adjustment operation based on the adjustment condition, and
the predetermined conveyance operation and the adjustment operation are synchronized.
